(19) United States
(12) Patent Application Publication
(10) Pub. No.: US 2008/0177990 A1
(43) Pub. Date: Jul. 24, 2008

(54) Synthesized assertions in a self-correcting processor and applications thereof

(75) Inventors: Soumya Banerjee, San Jose, CA (US); Michael Gottlieb Jensen, Ely (GB)

Correspondence Address: STERNE, KESSLER, GOLDSTEIN & FOX P.L.L.C., 1100 NEW YORK AVENUE, N.W., WASHINGTON, DC, 20005, US

(73) Assignee: MIPS Technologies, Inc., Mountain View, CA (US)

(21) Appl. No.: 11/655,267

(22) Filed: Jan. 19, 2007

(51) Int. Cl. G06F 9/445

(52) U.S. Cl. 712/227; 712/E09.028

(57) ABSTRACT

The present invention provides one or more synthesized assertions in a self-correcting processor, and applications thereof. In an embodiment, a synthesized assertion detects a mismatch between actual processor behavior and specified or expected processor behavior. When unexpected processor behavior is encountered, the synthesized assertion alters operation of the processor and causes the processor to behave in the specified or expected manner. Synthesized assertions in accordance with the present invention can detect and correct, for example, exception processing errors, instruction address errors, instruction opcode errors, and errors that can cause a processor to stall, as well as various other types of errors.

### FIELD OF THE INVENTION

The present invention generally relates to processors and processing systems. More particularly, it relates to synthesized assertions in a self-correcting processor, and applications thereof.

### BACKGROUND OF THE INVENTION

Functional verification in chip design involves verifying that a chip conforms to specification. This is a complex task, and it takes the majority of time and effort in most processor and electronic system design projects.

Techniques for performing functional verification in chip design exist. These techniques include logic simulation, emulation, and formal verification. While these techniques are useful, functional verification in chip design is becoming increasingly difficult as processor and electronic system complexity increases. As a result, it is likely that a chip will be sold before a problem can be detected using existing functional verification techniques. More than likely, a problem will first be detected by a customer running an application using the chip. Faulty chips in the field can result in recalls of thousands to millions of chips, resulting in heavy financial losses and inconvenience to both the manufacturer and the customer.

What are needed are new processors, systems and techniques that overcome the above mentioned deficiencies.

### BRIEF SUMMARY OF THE INVENTION

The present invention provides one or more synthesized assertions in a self-correcting processor, and applications thereof. In an embodiment, a synthesized assertion detects a mismatch between actual processor behavior and specified or expected processor behavior. When unexpected processor behavior is encountered, the synthesized assertion alters operation of the processor and causes the processor to behave in the specified or expected manner.

In one embodiment, a synthesized assertion is used to determine whether exceptions are being processed by the processor according to a predetermined order of priority. If the processor attempts to process exceptions in an unexpected order, the synthesized assertion overrides the current operation of the processor and forces the processor to process pending exceptions is a specified order.

In an embodiment, a synthesized assertion detects and corrects instruction address errors that can cause the processor to fetch instructions from incorrect addresses.

In an embodiment, a synthesized assertion detects and corrects instruction opcode errors.

In an embodiment, a synthesized assertion detects and corrects errors that can cause the processor to stall.

In one embodiment, a synthesized assertion alters operation of the processor by overriding and/or asserting control value(s) that cause the processor to behave in the specified or expected manner.

In one embodiment, a synthesized assertion alters operation of the processor by overriding and/or asserting data value(s) that cause the processor to behave in the specified or expected manner.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a diagram of a processor according to an embodiment of the present invention.

FIG. 2A is a diagram of an embodiment of the processor of FIG. 1 that includes an example synthesized assertion for detecting and correcting an address error.

FIG. 2B is a diagram further illustrating processor of FIG. 2A.

FIG. 2C is a second diagram further illustrating processor of FIG. 2A.

FIG. 2D is a third diagram further illustrating processor of FIG. 2A.

FIG. 3 is a diagram illustrating an example synthesized assertion for detecting and correcting an address error.

FIG. 4 is a diagram illustrating examples of synthesized assertions for detecting and correcting errors in an example multi-processor system.

FIG. 5A is a diagram illustrating example output signals and/or values generated by synthesized assertion(s) according to embodiment(s) of the present invention.

FIG. 5B is a diagram illustrating a synthesized assertion that generates debug information according to an embodiment of the present invention.

FIG. 5C is a diagram illustrating a first example topology for a synthesized assertion according to an embodiment of the present invention.

FIG. 5D is a diagram illustrating a second example topology for a synthesized assertion according to an embodiment of the present invention.

FIG. 6 is a diagram illustrating a synthesized assertion that detects an error and implements correction code according to an embodiment of the present invention.

FIG. 7 is a diagram illustrating a synthesized assertion that detects an error and uses a table of fixes to implement predetermined actions according to an embodiment of the present invention.

FIG. 8 is a diagram of an example system according to an embodiment of the present invention.

The present invention is described with reference to the accompanying drawings. The drawing in which an element first appears is typically indicated by the leftmost digit or digits in the corresponding reference number.

### DETAILED DESCRIPTION OF THE INVENTION

The present invention provides one or more synthesized assertions in a self-correcting processor, and applications thereof. In the detailed description of the invention that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

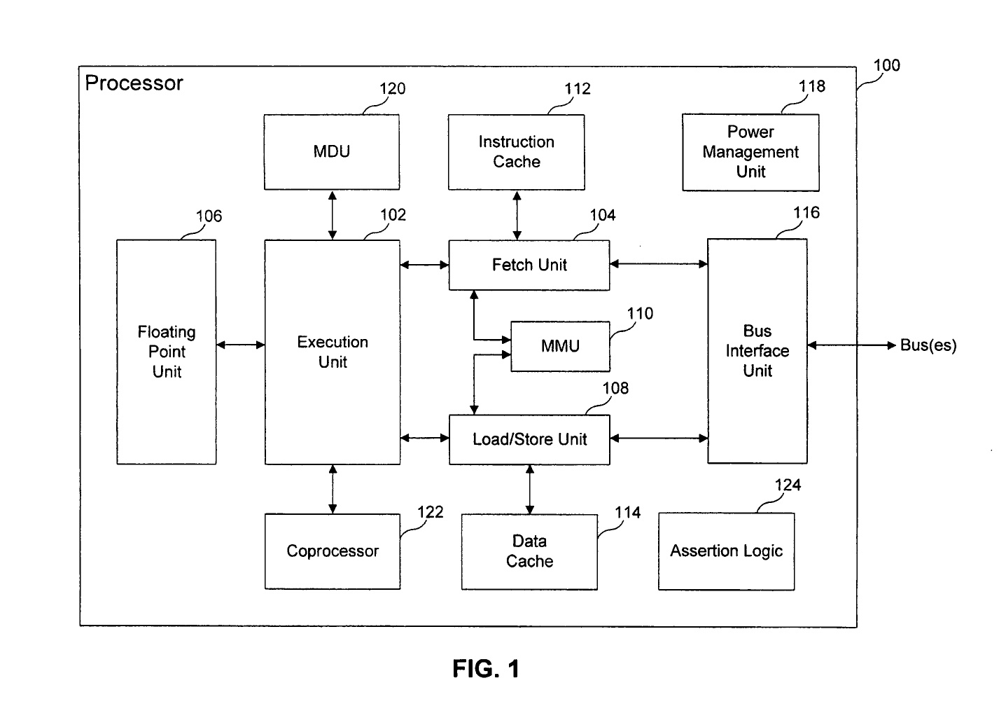

FIG. 1 is a diagram of a processor 100 according to an embodiment of the present invention. As shown in FIG. 1, processor 100 includes an execution unit 102, a fetch unit 104, a floating point unit 106, a load/store unit 108, a memory management unit (MMU) 110, an instruction cache 112, a data cache 114, a bus interface unit 116, a power management unit 118, a multiply/divide unit (MDU) 120, a coprocessor 122, and assertion logic 124. While processor 100 is described herein as including several separate components, many of these components are optional components that will not be present in each embodiment of the present invention, or components that may be combined, for example, so that the functionality of two components reside within a single component. Thus, the individual components shown in FIG. 1 are illustrative and not intended to limit the present invention.

Execution unit 102 preferably implements a load-store, Reduced Instruction Set Computer (RISC) architecture with single-cycle arithmetic logic unit operations (e.g., logical, shift, add, subtract, etc.). In one embodiment, execution unit 102 includes 32-bit general purpose registers (not shown) used for scalar integer operations and address calculations. Optionally, one or more additional register file sets can be included to minimize content switching overhead, for example, during interrupt and/or exception processing. Execution unit 102 interfaces with fetch unit 104, floating point unit 106, load/store unit 108, multiple-divide unit 120 and coprocessor 122.

Fetch unit 104 is responsible for providing instructions to execution unit 102. In one embodiment, fetch unit 104 includes control logic for instruction cache 112, a recoder for recoding compressed format instructions, dynamic branch prediction, an instruction buffer (not shown) to decouple operation of fetch unit 104 from execution unit 102, and an interface to a scratch pad (not shown). Fetch unit 104 interfaces with execution unit 102, memory management unit 110, instruction cache 112, and bus interface unit 116.

Floating point unit 106 interfaces with execution unit 102 and operates on non-integer data. As many applications do not require the functionality of a floating point unit, this component of processor 100 need not be present in some embodiments of the present invention.

Load/store unit 108 is responsible for data loads and stores, and includes data cache control logic. Load/store unit 108 interfaces with data cache 114 and other memory such as, for example, a scratch pad and/or a fill buffer. Load/store unit 108 also interfaces with memory management unit 110 and bus interface unit 116.

Memory management unit 110 translates virtual addresses to physical addresses for memory access. In one embodiment, memory management unit 110 includes a translation lookaside buffer (TLB) and may include a separate instruction TLB and a separate data TLB. Memory management unit 110 interfaces with fetch unit 104 and load/store unit 108.

Instruction cache 112 is an on-chip memory array organized as a multi-way set associative cache such as, for example, a 2-way set associative cache or a 4-way set associative cache. Instruction cache 112 is preferably virtually indexed and physically tagged, thereby allowing virtual-to-physical address translations to occur in parallel with cache accesses. In one embodiment, the tags include a valid bit and optional parity bits in addition to physical address bits. Instruction cache 112 interfaces with fetch unit 104.

Data cache 114 is also an on-chip memory array. Data cache 114 is preferably virtually indexed and physically tagged. In one embodiment, the tags include a valid bit and optional parity bits in addition to physical address bits. In embodiments of the present invention, data cache 114 can be selectively enabled and disabled to reduce the total power consumed by processor 100. Data cache 114 interfaces with load/store unit 108.

Bus interface unit 116 controls external interface signals for processor 100. In one embodiment, bus interface unit 116 includes a collapsing write buffer used to merge write-through transactions and gather writes from uncached stores.

Power management unit 118 provides a number of power management features, including low-power design features, active power management features, and power-down modes of operation.

Multiply/divide unit 120 performs multiply and divide operations for processor 100. In one embodiment, multiply/divide unit 120 preferably includes a pipelined multiplier, result and accumulation registers, and multiply and divide state machines, as well as all the control logic required to perform, for example, multiply, multiply-add, and divide functions. As shown in FIG. 1, multiply/divide unit 120 interfaces with execution unit 102.

Coprocessor 122 performs various overhead functions for processor 100. In one embodiment, coprocessor 122 is responsible for virtual-to-physical address translations, implementing cache protocols, exception handling, operating mode selection, and enabling/disabling interrupt functions. Coprocessor 122 interfaces with execution unit 102

Assertion logic 124 represents one or more synthesized assertions in accordance with the present invention. In embodiments, assertion logic 124 detects and/or corrects unexpected behavior of processor 100. Unexpected behavior can include, for example, any behavior that deviates from a specified architectural or a specified micro-architecture behavior.

In one embodiment, assertion logic 124 is used to determine whether exceptions are being processed according to a predetermined order of priority. If it is determined that the current or intended order of exception processing is not according to specification, assertion logic 124 overrides the current order of exception processing and forces processor 100 to process the exception as specified or expected.

In still other embodiments, assertion logic 124 is used to detect and/or correct, for example, errors in instruction opcodes that can result in the processor attempting to execute an illegal or reserved instruction, errors in instruction addresses that can result in fetch unit 104 fetching instructions incorrectly and/or a variety of other possible errors.

In an embodiment, assertion logic 124 is used to detect and fix address errors for branch instructions. During processing of a branch instruction, a branch hit/miss signal is sent to execution unit 102 by fetch unit 104 that indicates whether the branch was taken or not taken. When the branch instruction is resolved by execution unit 102, it is determined whether fetch unit 104 was accurate in its prediction by checking the hit/miss signal from fetch unit 104. If the branch was correctly predicted by fetch unit 104, execution continues as normal. If it is determined that the branch was incorrectly predicted, however, execution unit 102 redirects fetch unit 104 to fetch from the resolved address and flushes the pipeline of instructions fetched from the mis-predicted branch address. In a case where the branch was predicted correctly, but due to some error the address of the instruction after the branch instruction is not from the expected predicted address, assertion logic 124 causes execution unit 102 to redirect fetch unit 104 to fetch from the resolved address and flushes the pipeline of instructions fetched from the wrong address.

In an embodiment, assertion logic 124 is used to identify and/or prevent intellectual property theft. For example, in an embodiment, assertion logic 124 is set to react to a specific sequence of software events. Implementing this specific sequence of software events can then be used to trigger assertion logic 124. As a result, a particular error or theft detection code may be written to debug register 502.

In order to more fully appreciate the present invention and how assertion logic 124 operates, consider an example in which assertion logic 124 is used to detect and correct instruction address errors.

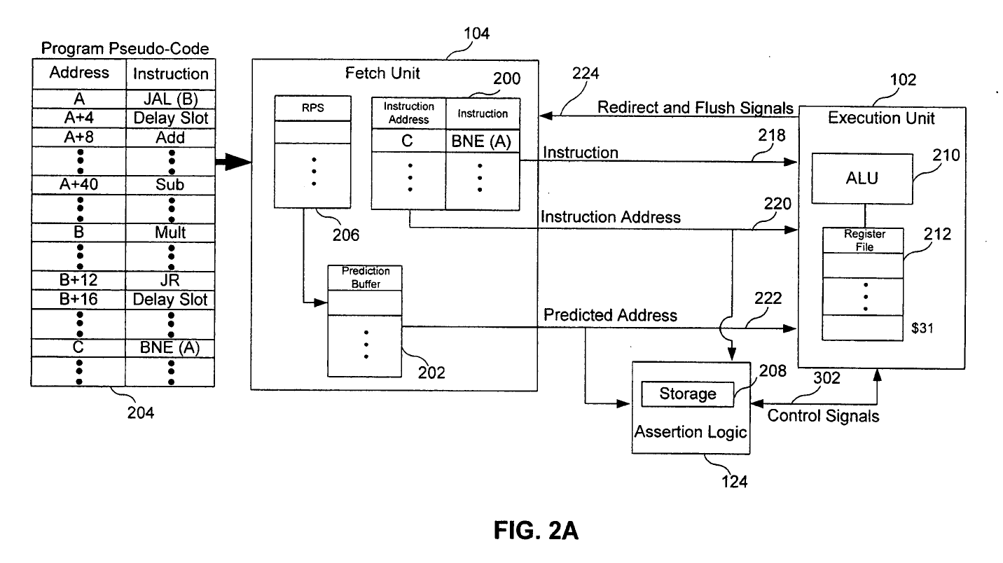

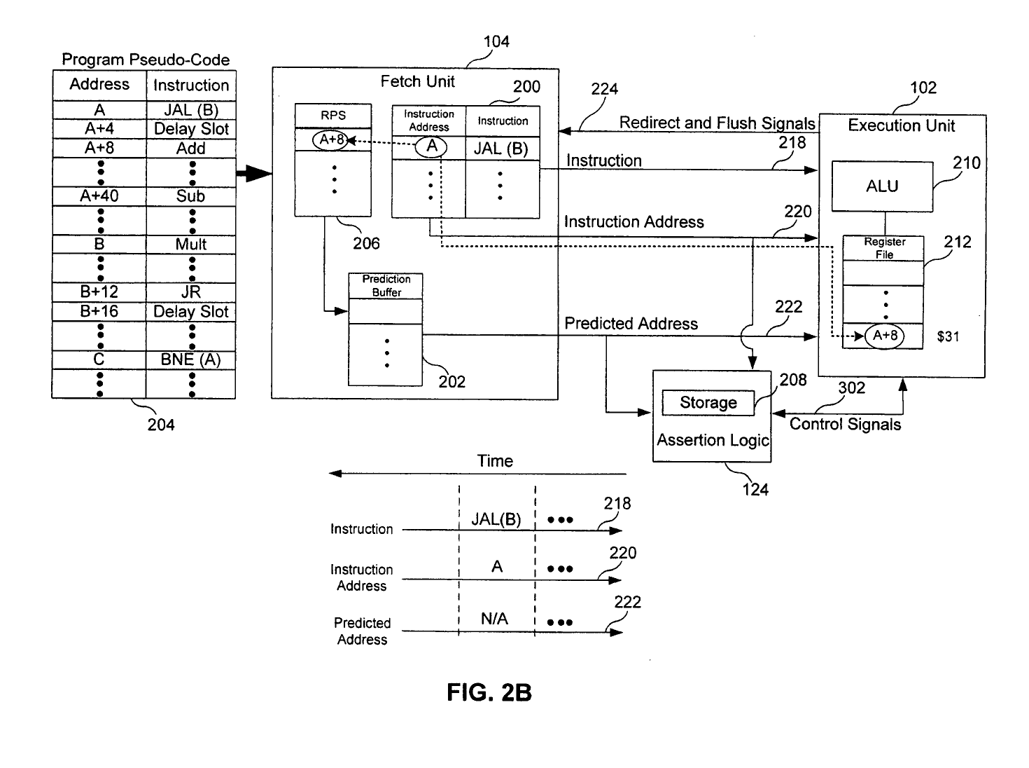

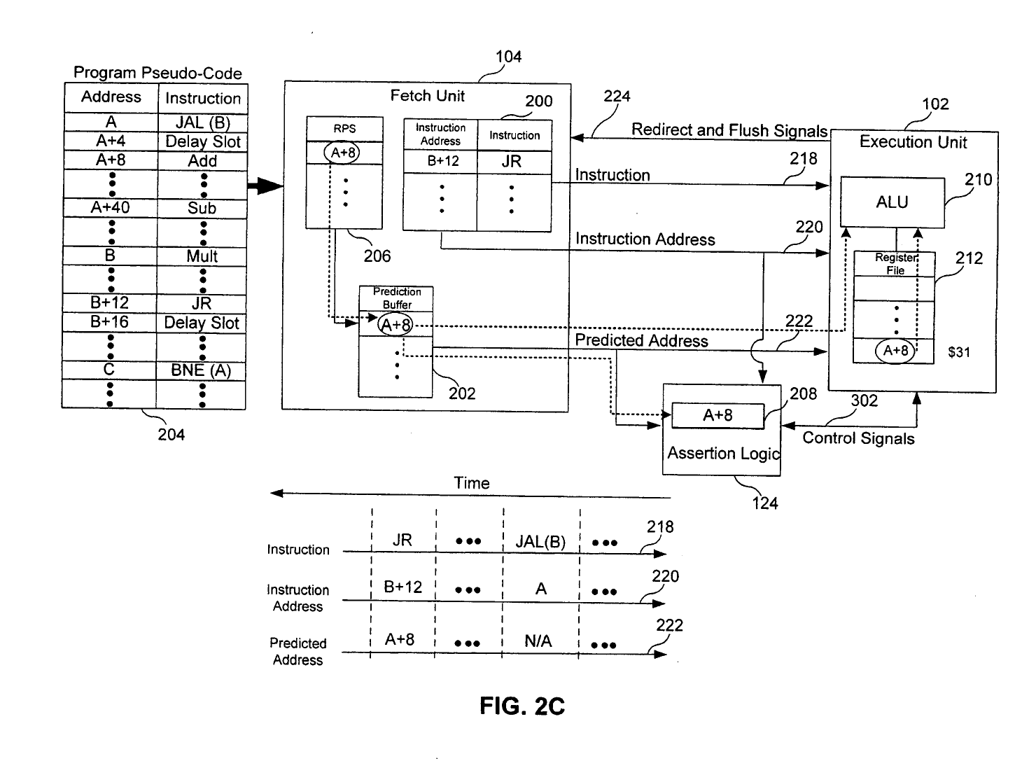

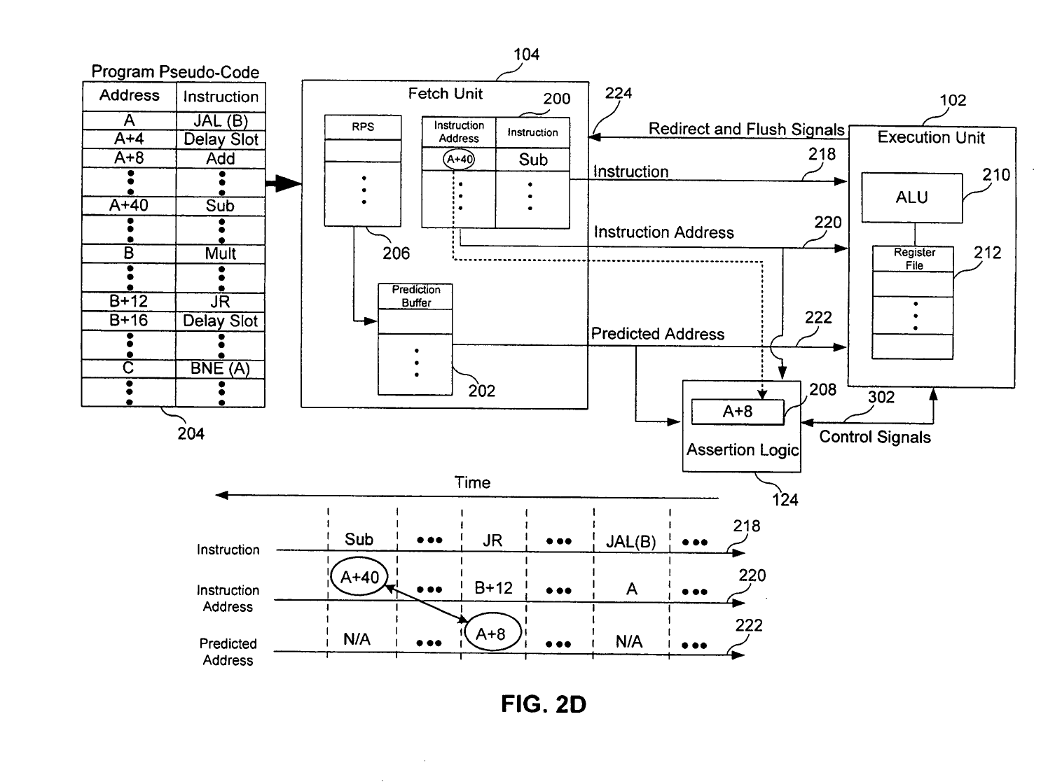

FIG. 2A is a diagram illustrating an embodiment of processor 100 that includes an example synthesized assertion for detecting and correcting an address error. Processors are designed to match particular architectural and micro-architectural specifications using, for example, a register transfer level (RTL) language such as VHDL, Verilog, SystemC et cetera. During the design process, assertions (i.e., blocks of RTL code) are used to add behavioral specifications to a design. These specifications define requirements on design behavior that can be checked statically using formal verification and dynamically during simulation. Assertions are used to catch errors during the design process that are not supposed to occur. Traditionally, at the end of the design process, all assertions are removed and are not synthesized onto the chip.

Contrary to conventional chip designs, selected assertions are synthesized onto a chip in accordance with the present invention and used to detect and/or correct errors during operation of the chip. For example, a hardware manufacturing error or stray radiation may corrupt a bit value in a processor. In accordance with the present invention, however, a synthesized assertion can be used to detect the corrupt value and assert the correct value.

In embodiments of the present invention, synthesized assertion logic 124 monitors the actual behavior of embodiments of processor 100 and compares actual behavior of processor 100 to expected behavior. When there is a mismatch between the actual behavior of processor 100 and the expected behavior of processor 100, assertion logic 124 forces or asserts the expected behavior. In embodiments of the present invention, synthesized assertions occupy approximately one percent of a chip's total die area and can potentially prevent the recall of millions of chips by self-correcting the behavior of processor 100 in the case of an error.

As shown in FIG. 2A, in an embodiment, processor 100 includes a fetch unit 104 that includes an instruction buffer 200 and a prediction buffer 202. Prediction buffer 202 is coupled to a return prediction stack (RPS) 206. Execution unit 102 includes an arithmetic logic unit 210 coupled to a register file 212. Fetch unit 104 is coupled to execution unit 102 by an instruction bus 218, an instruction address bus 220, a predicted address bus 222, and a redirect and flush signal bus 224.

Assertion logic 124 includes storage 208. Assertion logic 124 is coupled to fetch unit 104 and execution unit 102. As shown in FIG. 2A, assertion logic 124 is coupled to instruction address bus 220 and predicted address bus 222. A control signals bus 302 couples assertion logic 124 to execution unit 102.

Also shown in FIG. 2A is pseudo-code 204. Pseudo-code 204 is used below to illustrate the operation of the various components of processor 100 illustrated in FIG. 2A. The instructions included in pseudo-code 204 include a jump and link (JAL) instruction stored at a memory address A, an unspecified (Delay Slot) instruction stored at a memory address A+4, an addition (Add) instruction, stored at a memory address A+8, a subtraction (Sub) instruction stored at a memory location A+40, a multiplication (Mult) instruction stored at memory address B, a jump register (JR) instruction stored at memory address instruction B+12, an unspecified (delay slot) instruction stored at a memory address B+16, and a branch-if-not-equal (BNE) instruction at memory address C.

The instructions illustrated in program pseudo-code 204 cause processor 100 to perform in a manner that would be known to persons skilled in the relevant art. For example, the BNE instruction causes execution unit 102 to compare two values stored in two distinct registers in register file 212. If the values are unequal, the branch is taken. The JAL (address) instruction causes a jump to a subroutine starting at the address specified in parentheses. In the example of program pseudo-code 204, the JAL (B) instruction causes a jump to the Mult instruction at address B. When the JAL instruction is executed, a return address (i.e., A+8) is computed by processor 100 and stored in a specified register (e.g., register $31) of register file 212. The JR instruction causes a jump to an instruction pointed to by an address stored in a specific register (e.g., register $31).

As shown in program pseudo-code 204, the JAL instruction and the JR instruction each have a paired delay slot or delay instruction. The delay slot is used with certain instructions because processor 100 implements a pipelined architecture and there are data dependencies among pipeline stages. The delay slots allow for an extra cycle that is used to fetch the targets of the JAL and JR instructions from instruction cache 112. Although not shown, the BNE instruction also would have a paired delay slot or delay instruction. As would be known to persons skilled in the relevant art, however, the JAL and JR instructions, for example, of program pseudo-code 204 can be replaced with jump and link register compact (JALRC) and jump register compact (JRC) instructions, respectfully, which do not have paired delay slots or delay instructions, without departing from the intended scope of the present invention. Thus, it is to be appreciated that although the JAL and JR instructions are illustrated in FIGS. 2A-D, the present invention is not limited to using these instructions.

In operation, fetch unit 104 sends an instruction stored in instruction buffer 200 along with its associated instruction address to execution unit 102. The instruction is sent to execution unit 102 via bus 218. The instruction address is sent to execution unit 102 via bus 220. For JR (or JRC) instructions, for example, fetch unit 104 also sends a predicted address, retrieved from prediction buffer 202, to execution unit 102 via bus 222. The predicted address is the address used by fetch unit 104 to pre-fetch instructions before the JR (or JRC) instruction is resolved by execution unit 102.

A predicted address stored in prediction buffer 202 is initially calculated and stored in a return prediction stack (RPS) 206 during processing of a JAL instruction. During processing of the JR instruction, execution unit 102 checks the predicted address on bus 222 sent along with the JR instruction on bus 218 against the address stored in the appropriate return address register, i.e. register $31 of register file 212 for this example. If there is a mismatch between the predicted address on bus 222 and the address stored in $31, execution unit 102 redirects fetch unit 104 to fetch instructions from the address stored in register $31 and flushes the pipeline of processor 100 of instructions fetched from the incorrect address.

As noted above, assertion logic 124 includes storage 208. Storage 208 is used to store data such as a predicted address, read from bus 222, that is sent to execution unit 102 together with a JR instruction. If execution unit 102 determines that the predicted address on bus 222 and the address in register $31 match, assertion logic 124 stores the predicted address in storage 208 and uses the stored predicted address to verify proper operation of fetch unit 104, as described in more detail below.

FIG. 2B further illustrates the embodiment of processor 100 shown in FIG. 2A. FIG. 2B depicts the processing of the JAL instruction shown in pseudo-code 204. The JAL instruction is used in order to call a subroutine. Processing begins when the JAL instruction, at address A, is fetched from instruction cache 112 and placed in instruction buffer 200. As shown in FIG. 2B, the address of the JAL instruction is stored together in buffer 200 with the JAL instruction.

During processing of the JAL instruction, the address of the instruction to be fetched following return from the subroutine (i.e., A+8, which corresponds to the Mult instruction) is calculated and stored in return prediction stack 206. In an embodiment, return prediction stack 206 is four entries deep. As shown in FIG. 2B, the calculated address A+8 is also stored in register $31 of register file 212 in a later stage of the processing pipeline.

The time diagram in FIG. 2B illustrates the values passed from fetch unit 104 to execution unit 102 as a result of the JAL instruction. As shown in the time diagram, fetch unit 104 passes the instruction (i.e., JAL(B)) to execution unit 102 on bus 218. Fetch unit 104 passes the instruction address (i.e., A) to execution unit 102 on bus 220. Because there is not a predicted address associated with the JAL instruction, no predicted address value is passed to execution unit 102 on bus 222 as a result of the JAL instruction.

FIG. 2C is a second diagram that further illustrates the embodiment of processor 100 shown in FIG. 2A. FIG. 2C depicts the processing of the JR instruction shown in pseudo-code 204. The JR instruction is used to return from the subroutine called by the JAL instruction of program pseudo-code 204. Processing begins when the JR instruction, at address B+12, is fetched from instruction cache 112 and placed in instruction buffer 200. As shown in FIG. 2C, the address of the JR instruction is also stored together in buffer 200 with the JR instruction.

During processing of the JR instruction, the address A+8 is retrieved from return prediction stack 206 and stored in prediction buffer 202. In an embodiment, prediction buffer 202 is two deep. The address A+8 is also provided to both execution unit 102 and assertion logic 124 via predicted address bus 222. In an embodiment, arithmetic logic unit 210 compares the address received on predicted address bus 222 with the address value stored in register $31 of register file 212. If a match occurs, execution unit 102 provides a signal to assertion logic 124 to store the predicted address value in storage memory 208. Because the predicted address and the address in register $31 of register file 212 matched, the predicted address, A+8, is known to be the correct address of the instruction to be executed upon return from the subroutine call (i.e., the next instruction to be executed following the delay instruction at memory address B+16).

In the embodiment of processor 100, shown in FIG. 2C, when there is a mismatch between the predicted address for a JR instruction and the value stored in register $31 of register file 212, execution unit 102 will redirect fetch unit 104 to fetch instructions beginning at the address stored in register $31 of register file 212. Any instruction fetched from the predicted address is flushed, and storage 208 of assertion logic 124 is cleared.

The time diagram shown in FIG. 2C illustrates the values passed from fetch unit 104 to execution unit 102 as a result of the JR instruction. As shown in the time diagram, fetch unit 104 passes the instruction (i.e., JR) to execution unit 102 on bus 218. Fetch unit 104 passes the instruction address (i.e., B+12) to execution unit 102 on bus 220. Fetch unit 104 passes the predicted address value (A+8) to execution unit 102 on bus 222.

FIG. 2D is a third diagram that further illustrates the embodiment of processor 100 shown in FIG. 2A. FIG. 2D depicts the processing of the Sub instruction shown in pseudo-code 204. For purposes of this example, it is assumed that the Sub instruction is the first instruction fetched by fetch unit 104 following return from the subroutine called by the JAL instruction. Processing begins when the Sub instruction, at address B+40, is fetched from instruction cache 112 and placed in instruction buffer 200. As shown in FIG. 2D, the address of the Sub instruction is also stored together in buffer 200 with the Sub instruction.

As described above with reference to FIG. 2C, because the predicted address (A+8) associated with the JR instruction matched the address stored in register $31 of register file 212, execution unit 102 should receive an instruction from address A+8 after receiving the delay instruction at address B+16. However, it is assumed that due to an error, fetch unit 104 began fetching instructions from address A+40 following return from the subroutine call rather than address A+8.

As shown in the time diagram in FIG. 2D, during processing of the Sub instruction, fetch unit 104 passes the instruction (i.e., Sub) to execution unit 102 on bus 218. Fetch unit 104 passes the instruction address (i.e., A+40) to execution unit 102 on bus 220. No predicted address value is passed to execution unit 102 on bus 222 as a result of the Sub instruction because there is not a predicted address associated with a Sub instruction.

Assertion logic 124 reads the address value A+40 from bus 220 when it is passed to execution unit 102 and compares this address to the A+8 address stored in storage 208. Based on this comparison, assertion logic 124 detects the mismatch between the stored address in storage 208 and the instruction address on bus 220. In response to this detected mismatch, assertion logic 124 generates one or more control signal, which are provided to execution unit 102 via bus 302. These one or more control signals cause execution unit 102 to generate signals 224 that redirect fetch unit 104 to fetch from instruction address A+8 and to flush the pipeline of instructions fetched from address A+40 and onwards.

As illustrated by the above example, it is a feature of the present invention that synthesized assertions (represented for example by assertion logic 124 in FIGS. 2A-2D) can be used to detect mismatches between actual processor behavior and specified or expected processor behavior. Furthermore, when unexpected processor behavior is encountered, the synthesized assertions can alter operation of the processor and cause the processor to behave in the specified or expected manner.

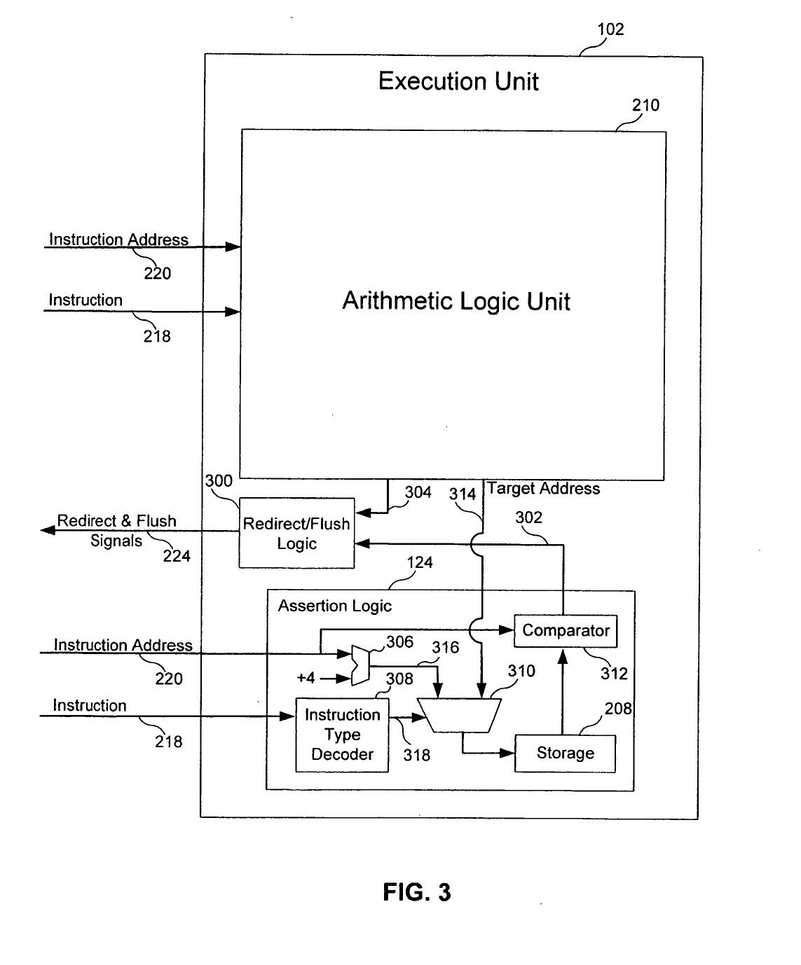

FIG. 3 is a diagram illustrating example synthesized assertion logic 124 inside execution unit 102 for detecting and correcting address errors according to an embodiment of the invention.

As shown in FIG. 3, execution unit 102 includes arithmetic logic unit 210, redirect and flush logic 300 and assertion logic 124.

In the present embodiment, assertion logic 124 includes an instruction type decoder 308, an adder 306, a multiplexer 310, storage 208 and a comparator 312. Assertion logic 124 receives as inputs instruction addresses on bus 220, instructions on bus 218 and target addresses on a bus 314. The target addresses are provided to assertion logic 124 from arithmetic logic unit 210.

Assertion logic 124 checks the address of an instruction coming in on bus 220. If the address does not match the expected instruction address, assertion logic 124 generates a redirect/flush signal 302. This signal is provided to redirect/flush logic 300. Arithmetic logic unit 210 also provides a redirect/flush signal 304 to redirect/flush logic 300. If either redirect/flush signal 302 or redirect/flush signal 304 is asserted, redirect/flush logic 300 generates redirect and flush signals 224, which as described above redirect fetch unit 104 to fetch from a specified address and flush certain stages of the pipeline of processor 100.

In an embodiment, for non jump/branch instructions, assertion logic 124 computes the address of the next expected instruction by using adder 306 to add a value of four to the address of the current instruction address on bus 220. This new address value is stored in storage 208. For jump/branch instructions, assertion logic 124 receives the target address of the next instruction on bus 314 from arithmetic logic unit 210. If a jump or branch instruction has an associated delay slot instruction, assertion logic 124 accounts for the delay slot instruction and uses the target address on bus 314 for the instruction following the delay slot instruction.

The target address on bus 314 or the address on bus 316, computed by adder 306, is selected using multiplexer 310 as the expected address for the next instruction. The select signal 318 for multiplexer 310 is provided by instruction type decoder 308. Instruction type decoder 308 receives instruction 218 as an input and determines, for example, whether the instruction is a jump instruction or a branch. If the instruction is a jump/branch instruction, instruction type decoder 308 accounts for any delay slot associated with the jump/branch instruction. In embodiments, instruction type decoder 308 determine the type of an instruction (e.g., whether an instruction is a jump instruction or a branch instruction, with or without a delay slot) using selected bits of the instruction that indicate instruction type. The expected instruction address for the next instruction is stored in storage 208.

In an embodiment, the instruction address on bus 220 is compared using comparator 312 against the expected address stored in storage 208. If there is a mismatch between the expected address stored in storage 208 and the instruction address on bus 220, comparator 312 causes redirect/flush logic 300 to place redirect and flush signals on bus 224. These signals cause fetch unit 102 to re-fetch from the expected address stored in storage 208 and flush stages of the pipeline of processor 100 that have been filled using an incorrect address. If there is a match between the expected address stored in storage 208 and the instruction address on bus 220, execution continues normally. In embodiments, assertion logic 124 accounts for stalls and bubbles in the pipeline of processor 100 when computing the address of the next expected instruction and/or storing the address of the next expected address in storage 208.

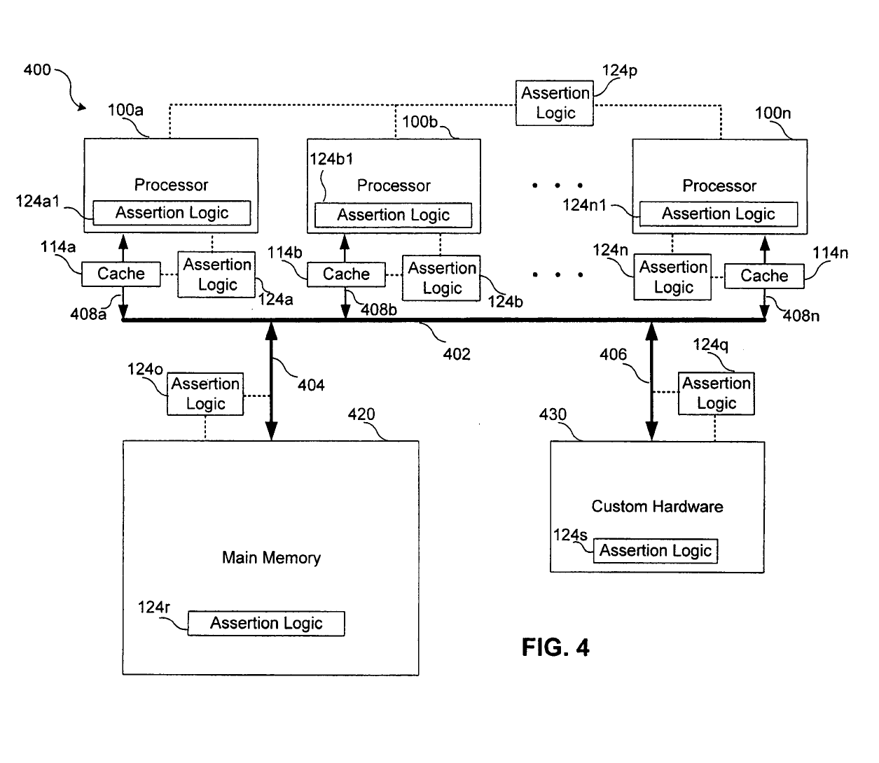

FIG. 4 is a diagram illustrating examples of synthesized assertions for detecting and correcting errors in an example multi-processor system 400 according to an embodiment of the invention. System 400 includes processors 100a-n coupled to corresponding caches 114a-n. As shown in FIG. 4, errors in the operation of caches 114a-n are detected and corrected by assertion logic 124a-n. The processors 100a-n are coupled to main memory 420 and custom hardware 430 via bus 402. Assertion logic 124o is coupled to bus 404 and main memory 420. Assertion logic 124q is coupled to custom hardware 430 and bus 406.

In an embodiment, the synthesized assertions represented by assertion logic 124a-n monitor the interactions between respective caches 114a-n and processors 100a-n. In an embodiment, one or more of the synthesized assertions has a built in timer. If a particular cache 114 fails to respond to a request by an associated processor 100 for data, for example, in a certain number of cycles, assertion logic 124 resets system 400 or a portion thereof such as the requesting processor as appropriate. In an embodiment, assertion logic 124 restarts the cache and resends the request for data to the cache. In another embodiment, assertion logic 124 monitors a bus 408 connecting a processor 100 with a cache 114. If the processor fails to make a request for data from the cache, for example, for a specific number of cycles, assertion logic 124 resets the processor, or takes an exception, or causes the processor to fetch instructions from a particular address in instruction memory.

In an embodiment, assertion logic 124o monitors bus 404 for data requests. If a data request to main memory 420 does not yield data, for example, in a specific number of cycles, assertion logic 124o may resend the request to memory 420 or cause system 400 to reset.

In an embodiment, assertion logic 124q monitors bus 406 for interactions between custom hardware 430 and processors 100. For example, if custom hardware 430 sends a request to a processor 100 and does not receive a reply, for example, within a specific number of cycles due to a hung processor, assertion logic 124q can cause system 400 or the hung processor to reset. In an embodiment, assertion logic 124q may resend the request before causing a system reset in order to verify, for example, that the processor is hung.

In an embodiment, assertion logic 124p shown in FIG. 4 monitors the interaction between processors 100a-n. If there is a deadlock between one or more of processors 100a-n, assertion logic 124 causes the hung processors 100 to reset.

As described herein, processors 100a-n may include assertion logic 124a1-n1, main memory 420 may include assertion logic 124r and custom hardware 430 may include assertion logic 124s to monitor actual behavior, compare actual behavior to expected behavior, and correct actual behavior if there is a mismatch.

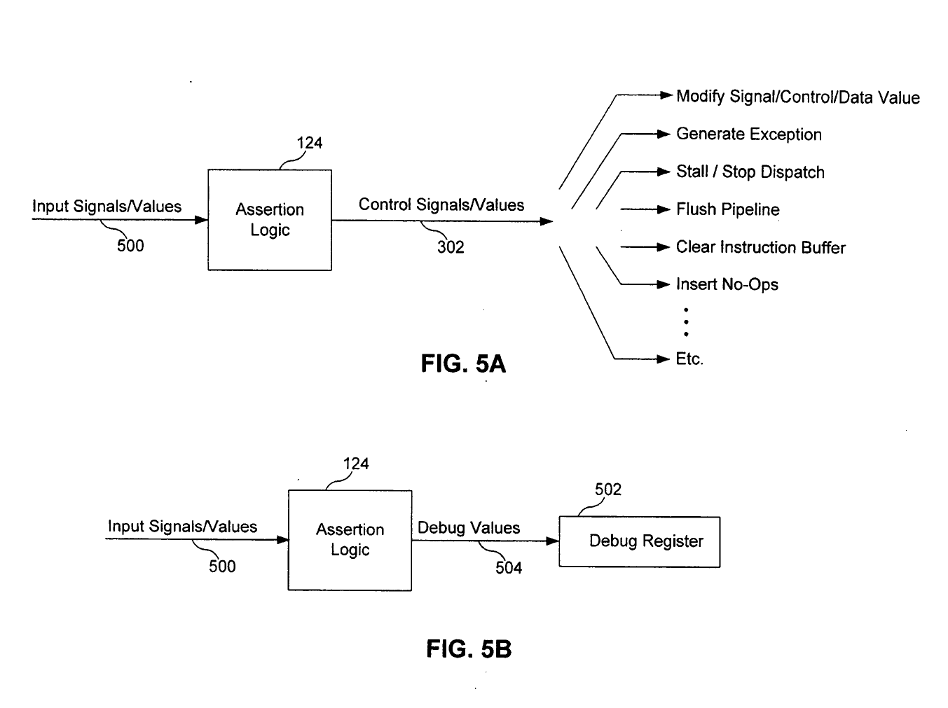

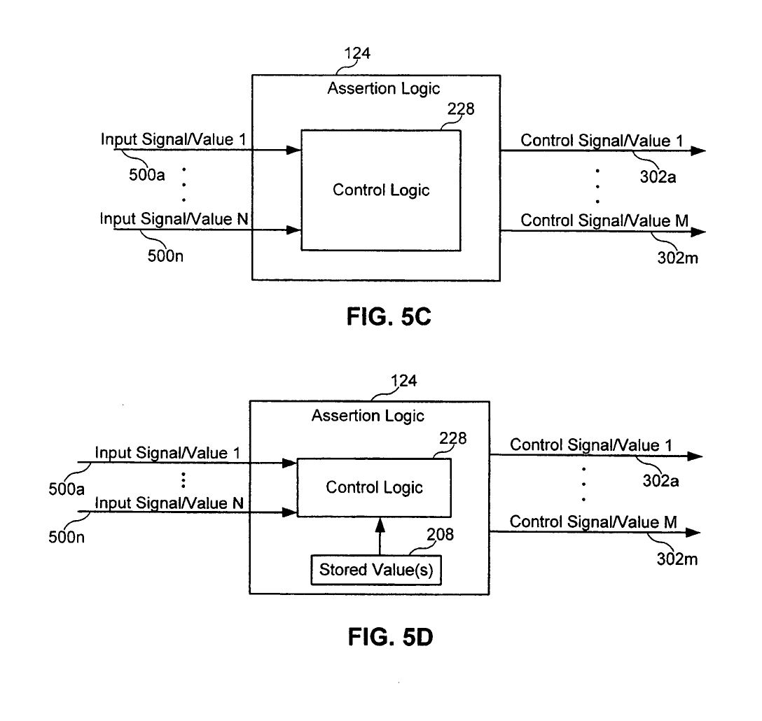

FIG. 5A is a diagram illustrating example control signals and/or values that can be generated by embodiments of assertion logic 124. In the example shown in FIG. 5A, assertion logic 124 receives input signals and/or values via a bus 500. The received input signals and/or values may be compared against each other, or they may be compared against values stored in storage 208 (see, e.g., FIG. 2A) of assertion logic 124. The comparisons are useful for identifying whether the actual behavior of processor 100 matches the expected or specified behavior of processor 100. If the comparison(s) indicate that there is a mismatch between the actual behavior and the expected behavior, assertion logic 124 generates one or more control signals, as depicted in FIG. 5A, and places these values on a bus 302. These control signals and/or values alter the behavior of processor 100 and make processor 100 behave as expected or specified. The control signals and/or values 302 that can be generated by assertion logic 124 include, but are not limited to, signals and/or values that override or modify existing signals or data, signals and/or values that cause an exception, signals and/or values that stall a pipeline or stop instruction dispatch, signals and/or values that flush one or more pipe stages, signals and/or values that start instruction fetching from a specific address, signals and/or values that insert no-ops or bubbles into the instruction stream, et cetera.

FIG. 5B is a diagram illustrating a synthesized assertion that generates and stores debug values. In the example shown in FIG. 5B, assertion logic 124 receives input signals and/or values via bus 500 and compares the received signals and/or values against each other or against values stored in storage 208 of assertion logic 124. If the comparison(s) indicate that there is a mismatch between the actual behavior and the expected behavior of processor 100, one or more debug values representing the error are generated and provided to a debug register 502 via a bus 504 for storage. The debug value(s) may be an error code, for example, that identifies the error. Possible errors might include exceptions not being handled according to a defined priority level, a processor stall due to a read pointer pointing to a null entry in the instruction buffer, an attempt to execute un-specified opcodes or to fetch instructions from an unexpected address, et cetera. Based on the debug value(s) stored in debug register 502, a user is able to determine the source of the error. The error may then be rectified, for example, as part of a firmware upgrade or a change in a sequence of program instructions that caused the error.

In embodiments of the present invention, assertion logic 124 both generates the control signals and/or values illustrated in FIG. 5A and generates and stores the debug values illustrated in FIG. 5B when a mismatch between actual processor behavior and expected or specified processor behavior is detected.

FIG. 5C is a diagram illustrating a first example topology for a synthesized assertion according to an embodiment of the present invention. In the example topology of FIG. 5C, N input signals and/or values are provided to control logic 228 on buses 500a-n of assertion logic 124. One or more of input signals and/or values are compared by control logic 228 to determine if there is a match between an actual behavior of processor 100 and an expected or specified behavior of processor 100. If there is a mismatch between an actual behavior and an expected or specified behavior, up to M control signals and/or values are generated and placed on buses 302a-m. These control signals are then used to make the behavior of processor 100 conform to the expected or specified behavior.

FIG. 5D is a diagram illustrating a second example topology for a synthesized assertion according to an embodiment of the present invention. In the example shown in FIG. 5D, up to N input signals received via buses 500a-n are compared against one or more stored values in storage 208. Values stored in storage 208 represent, for example, expected behaviors of processor 100. If there is a mismatch between values stored in storage 208 and one or more input signals and/or values, control logic 228 generate up to M control signals and/or values that are placed on buses 302a-m. These signals and/or values are then used to alter the behavior of processor 100 and make the behavior of processor 100 conform to expected or specified behavior. It is to be appreciated that some of the input signals and/or values may be compared against each other and some against stored values in storage 208.

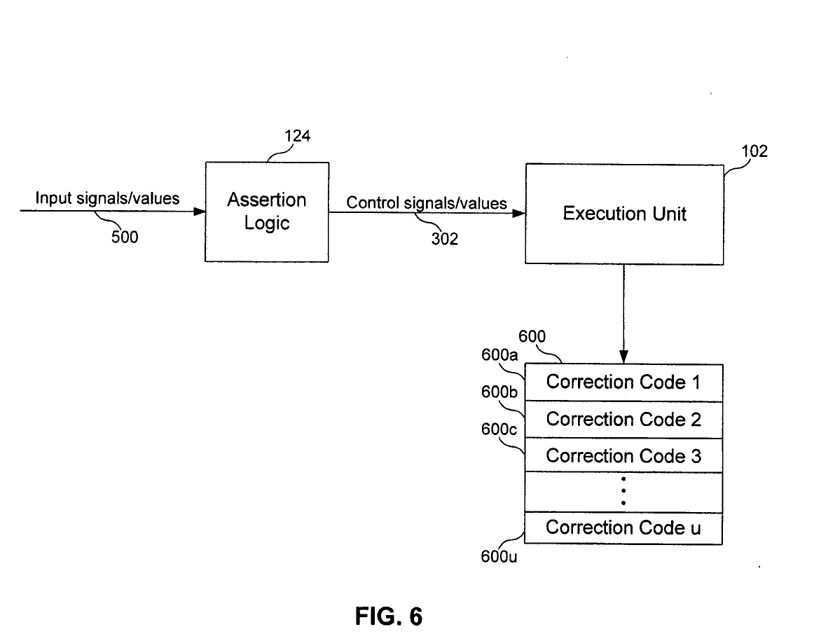

FIG. 6 is a diagram illustrating a synthesized assertion that detects an error and implements correction code according to an embodiment of the present invention. As described herein, assertion logic 124 determines whether a mismatch between an actual behavior of processor 100 and an expected behavior of processor 100 exists. Upon detecting that a mismatch does exists, assertion logic 124 generates control signal(s) and/or value(s) and places these signal(s) and/or value(s) on bus 302. The generated signal(s) and/or value(s) cause execution unit 102 to jump to and implement one or more of the correction codes 600a-u depicted in FIG. 6. In an embodiment, correction codes 600a-u are stored in a programmable memory.

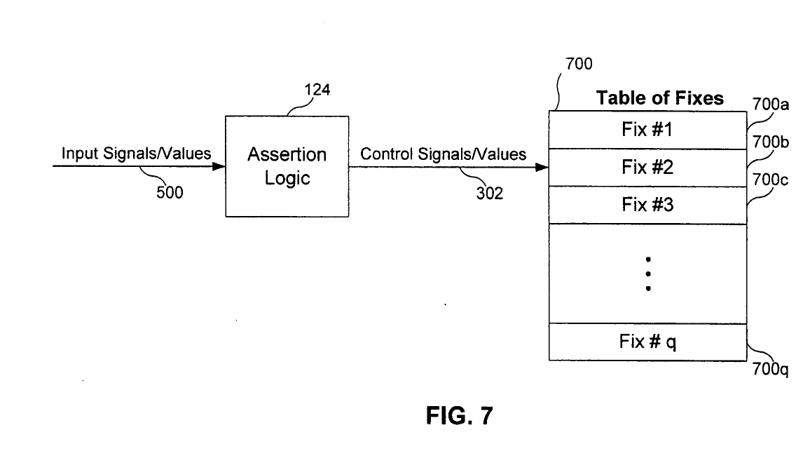

FIG. 7 is a diagram illustrating a synthesized assertion that detects an error and uses a table of fixes to implement predetermined actions according to an embodiment of the present invention. Table 700 stores Q fixes or actions to be performed. In this example embodiment, assertion logic 124 generates values control signal(s) and/or value(s) used to select one or more of the Q predetermined actions in table 700. Assertion logic 124 may be programmed to select a predetermined action corresponding to a generated control signal and/or value. For example, a generated value might correspond to fix 700c in table of fixes 700. In an embodiment, a chip manufacturer can pre-program fixes and associate specific values with specific fix 700a-q. Table 1 below illustrates an example of associations that may be formed between generated control signals and/or values and fixes 700. In addition, multiple values, as shown in Table 1, can be associated with a single fix 700, and a single value can be associated with multiple fixes 700.

TABLE 1

| Generated Values | Table of Fixes |
|---|---|
| Values #1 and #2 | Stall Signal |
| Value #3 | Flush Signal |
| Value #4 | Insert No-Op |
| Value #4 | Correction Code #1 |
| Value #5 | Correction Code #2 |

In the example shown above in Table 1, the pre-programmed table of fixes has the options of stalling a pipeline, flushing the pipeline, inserting a no-op in the pipeline, and/or jumping execution to a first or second correction code. In an embodiment, the generated values and the associated fixes may be programmed by an end user via firmware. For example, a match on values 1 and 2 generates a stall, a match on value 3 results in flushing of the pipeline, a match on value 4 causes a no-op to be inserted along with a jump to a first correction code and a match on value 5 causes a jump to a second correction code.

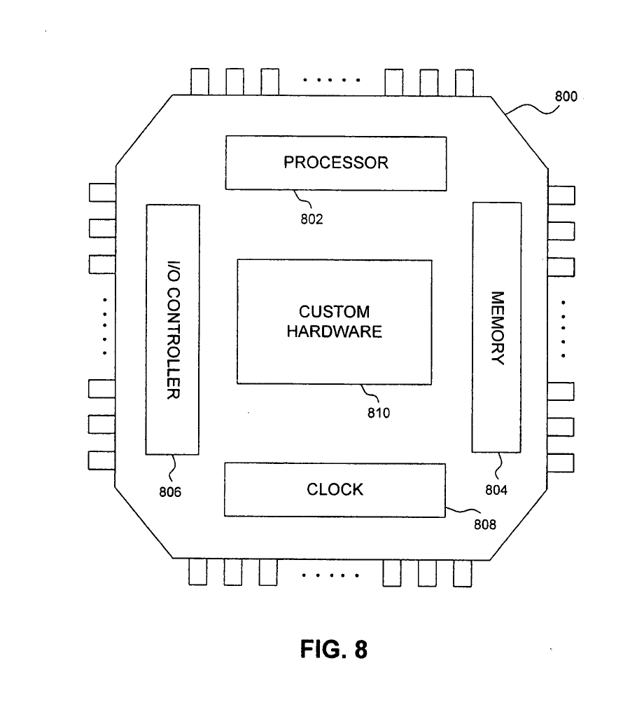

FIG. 8 is a diagram of an example system 800 according to an embodiment of the present invention. System 800 includes a processor 802, a memory 804, an input/output (I/O) controller 806, a clock 808, and custom hardware 810. In an embodiment, system 800 is a system on a chip (SOC) in an application specific integrated circuit (ASIC).

Processor 802 is any processor that includes features of the present invention described herein and/or implements a method embodiment of the present invention. In one embodiment, processor 802 includes an instruction fetch unit, an instruction cache, an instruction decode and dispatch unit, one or more instruction execution unit(s), a data cache, a register file, and a bus interface unit similar to processor 100 described above.

Memory 804 can be any memory capable of storing instructions and/or data. Memory 804 can include, for example, random access memory and/or read-only memory.

Input/output (I/O) controller 806 is used to enable components of system 800 to receive and/or send information to peripheral devices. I/O controller 806 can include, for example, an analog-to-digital converter and/or digital-to-analog converter.

Clock 808 is used to determine when sequential subsystems of system 800 change state. For example, each time a clock signal of clock 808 ticks, state registers of system 800 capture signals generated by combinatorial logic. In an embodiment, the clock signal of clock 808 can be varied. The clock signal can also be divided, for example, before it is provided to selected components of system 800.

Custom hardware 810 is any hardware added to system 800 to tailor system 800 to a specific application. Custom hardware 810 can include, for example, hardware needed to decode audio and/or video signals, accelerate graphics operations, and/or implement a smart sensor. Persons skilled in the relevant arts will understand how to implement custom hardware 810 to tailor system 800 to a specific application.

While various embodiments of the present invention have been described above, it should be understood that they have been presented by way of example, and not limitation. It will be apparent to persons skilled in the relevant computer arts that various changes can be made therein without departing from the scope of the invention. For example, the features of the present invention can be selectively implemented as design features. Furthermore, it should be appreciated that the detailed description of the present invention provided herein, and not the summary and abstract sections, is intended to be used to interpret the claims. The summary and abstract sections may set forth one or more but not all exemplary embodiments of the present invention as contemplated by the inventors.

For example, in addition to implementations using hardware (e.g., within or coupled to a Central Processing Unit (“CPU”), microprocessor, microcontroller, digital signal processor, processor core, System on Chip (“SOC”), or any other programmable or electronic device), implementations may also be embodied in software (e.g., computer readable code, program code and/or instructions disposed in any form, such as source, object or machine language) disposed, for example, in a computer usable (e.g., readable) medium configured to store the software. Such software can enable, for example, the function, fabrication, modeling, simulation, description, and/or testing of the apparatus and methods described herein. For example, this can be accomplished through the use of general programming languages (e.g., C, C++), hardware description languages (HDL) including Verilog HDL, VHDL, SystemC Register Transfer Level (RTL) and so on, or other available programs, databases, and/or circuit (i.e., schematic) capture tools. Such software can be disposed in any known computer usable medium including semiconductor, magnetic disk, optical disk (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets.

It is understood that the apparatus and method embodiments described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalence.

1. A processor, comprising:
a fetch unit that fetches instructions;
an execution unit that executes instructions; and
assertion check logic, coupled to the fetch unit and the execution unit, that checks whether the processor is operating in a specified manner,
wherein, if the processor is not operating in the specified manner, the assertion check logic generates at least one output signal that is used to alter operation of the processor so that the processor operates in the specified manner.

2. The processor of claim 1, wherein the assertion check logic compares a first input value to a second input value.

3. The processor of claim 1, wherein the assertion check logic compares an input value to a stored value.

4. The processor of claim 1, wherein the assertion check logic compares an instruction address to a predicted address.

5. The processor of claim 1, wherein the assertion check logic writes a debug value to a register.

6. The processor of claim 1, wherein an output signal of the assertion check logic alters a program counter value.

7. The processor of claim 1, wherein an output signal of the assertion check logic causes a pipeline flush.

8. The processor of claim 1, wherein an output signal of the assertion check logic causes a pipeline stall.

9. The processor of claim 1, wherein an output signal of the assertion check logic causes the processor to start executing software stored at a particular memory address.

10. The processor of claim 1, wherein an output signal of the assertion check logic alters a control value.

11. The processor of claim 1, wherein an output signal of the assertion check logic alters a data value.

12. The processor of claim 1, wherein an output signal of the assertion check logic is provided to a coprocessor.

13. A system, comprising:
a processor that includes assertion check logic that checks whether the processor is operating in a specified manner; and
memory coupled to the processor,
wherein, if the processor is not operating in the specified manner, the assertion check logic generates at least one output signal that is used to alter operation of the processor so that the processor operates in the specified manner.

14. The system of claim 13, wherein the assertion check logic compares an instruction address to a predicted address.

15. The system of claim 13, wherein the assertion check logic writes a debug value to a register of the processor.

16. The system of claim 13, wherein an output signal of the assertion check logic alters a program counter value.

17. The system of claim 13, wherein an output signal of the assertion check logic causes the processor to start executing software stored at a particular memory address.

18. The system of claim 13, wherein an output signal of the assertion check logic alters a control value.

19. The system of claim 13, wherein an output signal of the assertion check logic alters a data value.

20. The system of claim 13, wherein the assertion check logic compares a first input value to a second input value.

21. A tangible computer readable storage medium comprising a processor embodied in software, the processor comprising:
a fetch unit that fetches instructions;
an execution unit that executes instructions; and
assertion check logic, coupled to the fetch unit and the execution unit, that generates at least one output signal that is used to alter operation of the processor if the processor is not operating in a specified manner.

22. The tangible computer readable storage medium of claim 21, wherein the assertion check logic compares an instruction address to a predicted address.

23. The tangible computer readable storage medium of claim 21, wherein an output signal of the assertion check logic alters a program counter value.

24. The tangible computer readable storage medium of claim 21, wherein an output signal of the assertion check logic causes the processor to start executing software stored at a particular memory address.

25. The tangible computer readable storage medium of claim 21, wherein an output signal of the assertion check logic alters a control value.

26. The tangible computer readable storage medium of claim 21, wherein an output signal of the assertion check logic alters a data value.

27. The tangible computer readable storage medium of claim 21, wherein the processor is embodied in hardware description language software.

28. The tangible computer readable storage medium of claim 21, wherein the processor is embodied in one of Verilog hardware description language software and VHDL hardware description language software.

29-38. (canceled)
